(19) United States
(12) Patent Application Publication
(10) Pub. No.: US 2006/0203347 A1
(43) Pub. Date: Sep. 14, 2006

(54) Light reflection-diffusion sheet and method for manufacturing the same and display apparatus employing the same

(75) Inventors: Yun-Pin Yang, Taoyuan (TW); Chi-Wen Liao, Taoyuan (TW)

Correspondence Address: BACON & THOMAS, PLLC, 625 SLATERS LANE, FOURTH FLOOR, ALEXANDRIA, VA, 22314, US

(73) Assignee: Exploit Technology Co., Ltd., Taoyuan (TW)

(21) Appl. No.: 11/370,046

(22) Filed: Mar. 8, 2006

(30) Foreign Application Priority Data
Mar. 9, 2005 (TW) 94107061

(51) Int. Cl. G02B 5/02

(52) U.S. Cl. 359/599

(57) ABSTRACT

A light reflection-diffusion sheet used in a back-light module, in which a light source is disposed, comprises a reflection layer and a diffusion layer, which is formed on one surface of said reflection layer. The lights from said light source enter into said diffusion layer and are reflected by said reflection layer, and then emit via said diffusion. Said diffusion layer includes multiple diffusion particles and adhesive used for boning said multiple diffusion particles onto said reflection layer. A method for manufacturing said light reflection-diffusion sheet and a display apparatus employing said reflection-diffusion sheet are also disclosed.

### FIELD OF THE INVENTION

The present invention relates to a light reflection-diffusion sheet and a method for manufacturing the same, more particularly, to a light reflection-diffusion sheet for a backlight module of a flat panel display such as an LCD.

### BACKGROUND OF THE INVENTION

In recent years, flat panel display (FPD) has gradually replaced the conventional cathode ray tube (CRT) that is huge and heavy in the field of display, wherein the liquid crystal display (LCD) has become the market mainstream for its advantages of being less power consumption, full-colored, thin and light-weighted, and easy to carry. LCD is used extensively in various electronic devices, for example, the monitors of desktop and laptop computers, cellular phones, DV, PDA, DSC, LCD TV, etc.

Because “liquid crystal” itself is not a light-emitting source, however, a backlight module having a light source is additionally placed behind the panel, said backlight module uniformly induces the lights emitting from the light source to liquid crystal, after the lights reach through the liquid crystal panel, images will be displayed on the LCD such that the information will be transmitted to the viewers' eyes. Thus the backlight module typically meets the requirements as follows: in the aspect of optical property, in order to achieve the desired display quality, the brightness displayed is adequate and uniform, and both the orientation angle (i.e. viewing angle) and the color rendering of emitted lights should be good; in the aspect of electrical property, performances of low power consumption and low noise, etc. is required; in the aspect of mechanical property, the device is expected to be thin, light-weighted, and impact-proof, etc., so that said backlight module can be used on various devices and in different occasions.

Light source of the conventional backlight module can be divided into two types: “linear light source” and “point light source”, both for generating the planer light source (the operation principles will be detailed depicted afterwards) needed for liquid crystal panel. Linear light source typically employs the fluorescent lamp (FL) and the cathode fluorescent lamp (CFL), etc., currently the cold cathode fluorescent lamp (CCFL) is the most common and its advantage is to easily produce the planer light source with uniform luminance; the drawback is the high power consumption. Point light source emits lights mostly using light emitting diode (LED), the power consumed is much less than that of CCFL, however, it is not easy to produce a planer light source with uniform luminance.

Backlight module can be distinguished to “direct-in lighting type” and “edge lighting type” according to the light source position, the former directly disposes said light source right below the liquid crystal panel and the latter disposes said light source to the side. FIGS. 1 and 2 illustrate the conventional direct-in lighting type backlight module normally uses linear light source 21 and point light source 22, the lights emitted from light sources 21 and 22 can directly irradiate to liquid crystal panel 1. Though the part closer to light sources 21 and 22 is brighter and the other farther is darker due to the nonuniformity of the light, therefore the disposition of a diffusion sheet/film 3 between said light sources 21 and 22 and said liquid crystal panel 1 is necessary, and uniformly diffusing the lights by the diffusion particles on the top of the panel 1. In addition, a reflection sheet 4 disposed below or on the side of light sources 21 and 22 is reflected by the leaked lights from the bottom or the side such that leakage of lights can be prevented and enhance the effectiveness to using light sources 21 and 22.

FIG. 3 shows the conventional edge lighting type backlight module. It is clearly understood that the most significant differences between the edge lighting type and the direct-in lighting type is that a light guide plate 5 needs to be disposed additionally due to the disposition of light source 21 on the side of the backlight module, via the diffusion points on the bottom of the light guide plate 5, the lights will be diffused to each angle and emitted from the front of light guide plate 5, then uniformly diffused through diffusion sheet 3 to liquid crystal panel 1 as described above. The effect of reflection sheet 4 herein is the same as that of the direct type reflection sheet 4 as described.

From the description above, it is necessary to dispose the diffusion sheets and the reflection sheets for the direct-in lighting or the edge lighting type backlight module so that the light can be uniformly diffused and used to the light source more efficiently.

To achieve a preferable brightness (light convergence) and a more uniform diffusion effect, the strategy commonly adopted in the industry at present is to use several pieces of diffusion sheets above the light source (for example, CCFL or LED) or the light guide plate. Using the several pieces of diffusion sheets, however, will not only increase the manufacturing cost for the diffusion sheet but also cause the raise in time for assembly, cost for a much more complicated assembly process, and the probability to occurrences of pollution. Other than that, excessive diffusion sheets will increase the size and weight of said backlight module against the requirements to be “light and thin.”

Hence the issue that the backlight module technology is facing right now is how to reduce the assembly complexity without bringing down but even to enhance the electrical performances (such as brightness and uniformity) and reduce the amount of the diffusion sheets used. The present invention can satisfy such needs.

### SUMMARY OF THE INVENTION

One of the purposes of the present invention is to provide a light reflection-diffusion sheet with the effects of reflection, diffusion, light convergence, and light mixing, so that the lights after reflection further can be uniformly diffused and increase the brightness, thereby the amount of the diffusion sheets needed can be reduced and this will lead to cost reduction, improved effectiveness, and reduction in size and weight of said backlight module.

One of the purposes of the present invention is to provide a method to produce said light reflection-diffusion sheet with the effects of reflection, diffusion, light convergence, and light mixing, as described above. Said method can be easily introduced to the current manufacture process; it has an outstanding compatibility and will not cause extra manufacturing cost.

In accordance with one aspect of the present invention, a light reflection-diffusion sheet for a backlight module, wherein a light source is disposed, comprises a reflection layer and a diffusion layer formed on one surface of said reflection layer. The lights from said light source enter into said diffusion layer and are reflected by said reflection layer, and then emit via said diffusion. Said diffusion layer comprises multiple diffusion particles and adhesive used for boning said multiple diffusion particles onto said reflection.

In accordance with another aspect of the present invention, a method for forming the light reflection-diffusion sheet for said backlight module as described above comprises steps of providing a non-transparent layer as a reflection layer; and forming a diffusion layer on one surface of said non-transparent layer.

In accordance with further aspect of the present invention, a method for forming the light reflection-diffusion sheet for said backlight module comprises steps of providing a transparent or semi-transparent layer; forming a diffusion layer on one surface of said transparent or semi-transparent layer; and forming a non-transparent layer on the other surface of the transparent or semi-transparent layer, said transparent or semi-transparent layer and said non-transparent layer serving as the reflection layer.

In accordance with further aspect of the present invention, a display apparatus is provided, which employs said reflection-diffusion sheet as described above.

### BRIEF DESCRIPTION OF THE DRAWINGS

The following rawings are only for illustrating the mutual relationships between the respective portions and are not drawn according to practical dimensions and ratios. In addition, the like reference numbers indicate the similar elements.

FIG. 1 illustrates the conventional direct-in lighting type backlight module commonly using a linear light source.

FIG. 2 illustrates the conventional direct-in lighting type backlight module commonly using a point light source.

FIG. 3 illustrates the conventional edge lighting backlight module.

FIG. 4 illustrates the structure of the light reflection-diffusion sheet of an embodiment according to the present invention.

FIG. 5 illustrates the structure of the light reflection-diffusion sheet of another embodiment according to the present invention.

FIG. 6 illustrates the structure of the light reflection-diffusion sheet of further embodiment according to the present invention.

FIG. 7 illustrates the wavy light reflection-diffusion sheet of an embodiment according the present invention.

FIG. 8 shows the forming of the light reflection-diffusion sheet of the present invention in a wavy shape as shown in FIG. 7, with roll-pressing method.

FIG. 9 shows a display apparatus, which employs the light reflection-diffusion sheet in wavy shape of the present invention in the conventional direct-in lighting type backlight module using the point light source.

### DETAILED DESCRIPTION OF PREFERRED EMBODIMENTS

The light reflection-diffusion sheet for a backlight module of the present invention mainly comprises a reflection layer and a diffusion layer. Said diffusion layer is formed on one surface of said reflection layer. In operation, the lights of the light source in the backlight module enter into said diffusion layer and are reflected by said reflection layer, and then emit via said diffusion layer. Light-colored materials with high reflection rate, such as a white non-transparent resin film or metals like silver (Ag) and aluminum (Al) etc., can be used for said reflection layer, and the material for said diffusion layer, for example, PMMA or SiO2, is mainly to form the roughness of fine surface in order to provide the uniform light diffusion effect with light convergence function (i.e. to advance luminance).

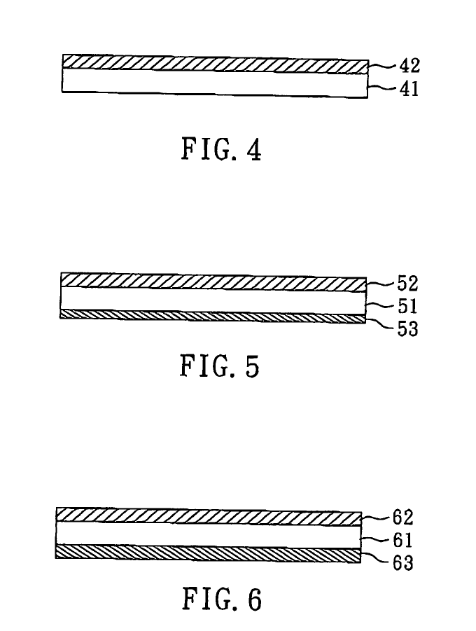

FIG. 4 discloses a preferable embodiment of a light reflection-diffusion sheet for a backlight module of the present invention. Said light reflection-diffusion sheet includes a reflection layer 41 and a diffusion layer 42; said diffusion layer 42 is formed on one surface of said reflection layer 41. In said embodiment, the material for reflection layer 41 is a white non-transparent resin film, which is preferably selected from PET, TAC, PEN, polymalonate, polyimide, polyether, polycarbonate, polyamine, polyethylene, polypropylene, polyvinylalcohol, and the equivalents. Thickness of said resin film is preferably from 20 to 500 μm, and more preferably from 50 to 200 μm.

Said diffusion layer 42 includes multiple diffusion particles (not shown) and adhesive used for bonding said multiple particles onto said reflection layer 41. In this embodiment, the material for said adhesive is thermoplastic polymer resin, which is preferably selected from the monomer or polymer of (meth)acrylate, polyester, polycarbonate, polystyrene, polymethyl pentene, and the equivalents. In which the monomer or polymer of (meth)acrylate is preferably selected from polymethyl(meth)acrylate and polyethyl(meth)acrylate. Said polyester is preferably polyethylene terephthalate or polypropyrene terephthalates, etc. The ratio of weight percentage of said adhesive in said diffusion layer can be from 1 weight % to 60 weight %, preferably from 1 weight % to 50 weight %, and more preferably from 1 weight % to 30 weight %. In this embodiment, said diffusion particles is preferably the organic diffusion particles selected from PMMA, polymethoxy benzyl acetate (PMBA), PVC, silicon gel, polyurethane (PU), polystyrene (PS) and the equivalents, or the non-organic diffusion particles selected form SiO2, Al2O3, and the equivalents. The ratio of weight percentage of said diffusion particles in diffusion layer 42 can be from 1 weight % to 99 weight %, preferably from 10 weight % to 60 weight %, and more preferably from 5 weight % to 50 weight %. The thickness diffusion layer 42 ranges preferably from 50 to 300 μm.

The light reflection-diffusion sheet of such embodiment can be formed using the following method: first of all, dispoing a white non-transparent substrate, serving as said reflection layer 41, on a coating station, placing the materials used to construct said diffusion layer 42 into said coating station, and then coating the materials onto one surface of said white non-transparent substrate; or applying said materials onto one surface of said white non-transparent substrate by static spraying method, at last drying out the formed light reflection-diffusion sheet by disposing it in a float-type constant temperature and humidity chamber.

FIG. 5 discloses another preferable embodiment of a light reflection-diffusion sheet for a backlight module of the present invention. Said light reflection-diffusion sheet includes a transparent or semi-transparent layer 51, a diffusion layer 52, and a non-transparent layer 53. Said diffusion layer 52 and non-transparent layer 53 are formed on the opposite surfaces of said transparent or semi-transparent layer 51, respectively. Said transparent or semi-transparent layer 51 and non-transparent layer 53 serve as a reflection layer whose light convergence effect is more preferable than that of FIG. 4. In this embodiment, transparent or semi-transparent layer 51 can be formed by using the resin film material for reflection layer 41 in FIG. 4 as described. Said non-transparent layer 53 is metal that is preferably silver (Ag), aluminum (Al), or the equivalents. The thickness of said metal layer 53 is preferably from 0.5 to 3.0 Ang.

The light reflection-diffusion sheet of this embodiment can be formed using the following method: first disposing a transparent or semi-transparent substrate, serving as said transparent or semi-transparent layer 51, on a coating station, setting the materials used to construct said diffusion layer 52 into said coating station, and then coating the materials onto one surfaces of said transparent or semi-transparent substrate; or applying said materials on one surface of said white non-transparent substrate by static spraying method, then gilding a layer of metal serving as metal layer 53 on the other surface of said substrate, preferably by but not limited to the methods of electroplating or evaporating, at last drying out the formed light reflection-diffusion sheet by disposing it in a float-type constant temperature and humidity chamber.

FIG. 6 discloses another more preferable embodiment of a light reflection-diffusion sheet for in a backlight module, which includes a transparent or semi-transparent layer 61, a diffusion layer 62, and a non-transparent layer 63. The difference of FIG. 6 in comparison to that of FIG. 5 is that, in this embodiment, material used for said non-transparent layer 63 is white resin film as for the reflection layer 41 in FIG. 4.

The major difference of the forming method for such light reflection-diffusion sheet in comparison to that of described FIG. 5 is that, white resin film 63 is preferably formed on the other surface of said transparent or semi-transparent layer 61 by, but not limited to, the roller bonding method.

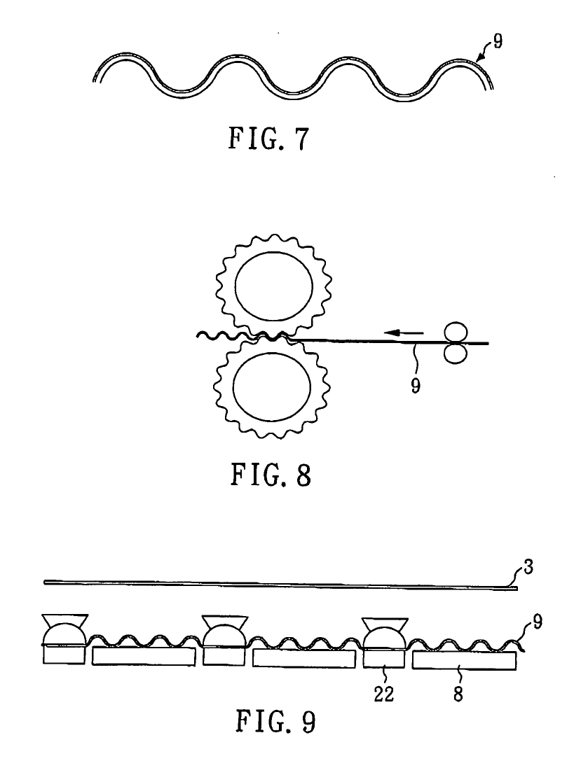

The light reflection-diffusion sheet for a backlight module of the present invention can be in flat or wavy shape, preferably in wavy shape, such as the wave-shaped light reflection-diffusion sheet 9 illustrated in FIG. 7. Such a wavy shape can be formed by any suitable method. FIG. 8 exemplify a method shows that forms said light reflection-diffusion sheet 9 in wavy shape by roll-pressing the sheet 9 through between a pair of rollers having their wavy surfaces engaging with each other.

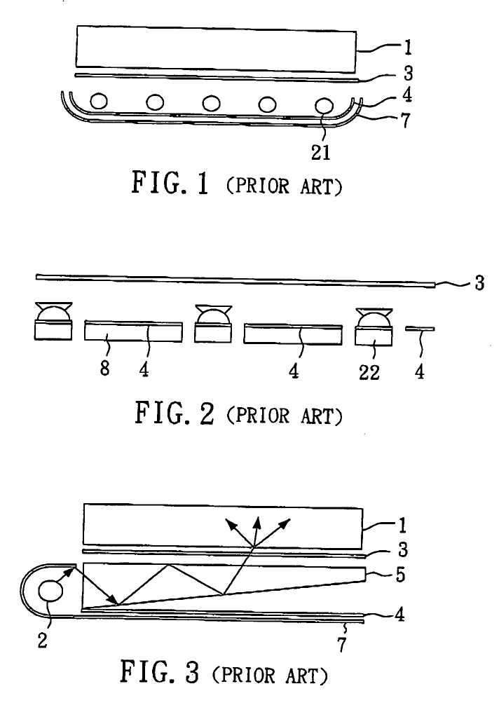

The light reflection-diffusion sheet for a backlight module formed in accordance with the present invention can be directly used in various types of known display apparatus, for example, the backlight modules of various types of known liquid crystal display apparatus shown in FIGS. 1, 2, and 3, without additional corrections to said display apparatus. Embodiment of an example is shown as FIG. 9, wherein a direct-in lighting type backlight module with point light source 22 for a display apparatus is illustrated, and the wave-shaped light reflection-diffusion sheet 9 of the present invention is directly applied to said backlight module. It can be seen from this embodiment that the display apparatus using the light reflection-diffusion sheet of the present invention is able to increase the light diffusion and decrease the number of the diffusion sheet that are needed above the light guide plate, linear light source (e.g. CCFL), or point light source (e.g. LED), so that the purpose to make the backlight module thin and light-weighted, and simplify manufacturing complexity can be achieved.

Following is an example provided, in which tests of optical property of said light reflection-diffusion sheet of the present invention and of the conventional reflection sheet are compared. Wherein the light reflection-diffusion sheet (reflection sheet A) of the present invention is manufactured according to said embodiment, the structure is as follows:
Reflection layer: white PET material, 50 μm thickness;
Diffusion layer: material including polyethylene terephthalate (PET) and diffusion particles;
Diffusion particle: 30 weight % of PMMA, 40 weigh % of silicon gel, and 30 weight % of PVC;
Weight percentage of the diffusion particles in the diffusion layer: about 45 weight %.

In this embodiment, the conventional reflection sheet (reflection sheet B) used for comparison is a typical reflection sheet without diffusion function.

The testing environment is as follows:
Testing machine: luminance meter (BM-7Fast)
Backlight source (B/L): 15-inch edge light
Testing height (i.e. the height from lens to reflection sheet): 50 cm
Testing method: uniformly taking the regions with 5 points, 9 points, and 13 points on said light reflection-diffusion sheet A and said reflection sheet B, respectively, and selecting three positions at the horizontal height, wherein one is closer, the second is medium, and the third is farther with a distance of about 15 cm between each other, then measuring the luminance and evenness.

The test results are shown in Table 1 below.

TABLE 1

| | 5 points | | 9 points | | 13 points | |
|---|---|---|---|---|---|---|
| | Lumi- | Even- | Lumi- | Even- | Lumi- | Even- |
| | nance | ness | nance | ness | nance | ness |
| | (cd/m * 2) | (%) | (cd/m * 2) | (%) | (cd/m * 2) | (%) |
| Reflection | 2405 | 86.04 | 2491 | 86.17 | 2265 | 78.86 |
| sheet A | | | | | | |
| Reflection | 1386 | 66.03 | 1390 | 65.73 | 1250 | 58.32 |
| sheet B | | | | | | |

This test shows that the light reflection-diffusion sheet of the present invention do have a better optical performance than the conventional reflection sheet. Therefore the desired purpose to combine the effects of reflection, diffusion, light convergence, and lights mixing can be achieved. Further the demand for the backlight module technology to reduce the amount of diffusion sheets needed, the assembly complexity, and the size and weight can be satisfied.

While the embodiments of the present invention is illustrated and described, various modifications and alterations can be made by persons skilled in this art. The embodiments of the present invention are therefore described in an illustrative but not restrictive sense. It is intended that the present invention may not be limited to the particular forms as illustrated, and that all modifications and alterations which maintain the spirit and realm of the present invention are within the scope as defined in the appended claims.

We claim:

1. A light reflection-diffusion sheet for a backlight module, said backlight module having a light source, said light reflection-diffusion sheet comprising:
a reflection layer; and
a diffusion layer, formed on one surface of said reflection layer,
wherein lights from said light source enter into said diffusion layer and are reflected by said reflection layer, and then emit via said diffusion.

2. The light reflection-diffusion sheet according to claim 1, wherein said reflection layer is comprised of a transparent or semi-transparent layer and a non-transparent layer, and said non-transparent layer and said diffusion layer are formed on the opposite surfaces of said transparent or semi-transparent layer.

3. The light reflection-diffusion sheet according to claim 2, wherein said non-transparent layer is in color white.

4. The light reflection-diffusion sheet according to claim 1, wherein said reflection layer is a non-transparent layer.

5. The light reflection-diffusion sheet according to claim 4, wherein said non-transparent layer is in color white.

6. The light reflection-diffusion sheet according to any of claims 2 to 5, wherein the material for said transparent or semi-transparent and said non-transparent layer is resin film.

7. The light reflecition-diffusion sheet according to claim 6, wherein said resin film is selected from PET, TAC, PEN, polymalonate, polyimide, polyether, polycarbonate, polyamine, polyethylene, polypropylene, and polyvinylalcohol.

8. The light reflection-diffusion sheet according to claim 6, wherein the thickness of said resin film is from 25 to 500 μm.

9. The light reflection-diffusion sheet according to claim 6, wherein the thickness of said resin film is from 50 to 200 μm.

10. The light reflection-diffusion sheet according to claim 2, wherein said non-transparent layer is metal.

11. The light reflection-diffusion sheet according to claim 10, wherein said metal is selected from silver (Ag) and aluminum (A).

12. The light reflection-diffusion sheet according to claim 10, wherein the thickness of said metal layer is from 0.5 to 3.0 Ang.

13. The light reflection-diffusion sheet according to claim 1, wherein said diffusion layer comprising:
multiple diffusion particles; and
adhesive for boning said multiple diffusion particles onto said reflection layer.

14. The light reflection-diffusion sheet according to claim 13, wherein the material for said adhesive is thermoplastic polymer resin.

15. The light reflection-diffusion sheet according to claim 14, wherein said thermoplastic polymer resin is selected from the monomer or polymer of (meth)acrylate, polyester, polycarbonate, polystyrene, and polymethyl pentent.

16. The light reflection-diffusion sheet according to claim 15, wherein the monomer or polymer of said (meth)acrylate is selected from polymethyl(meth)acrylate and polyethyl(meth)acrylate, etc.

17. The light reflection-diffusion sheet according to claim 15, wherein said polyester is polyethylene terephthalate or polypropyrene terephthalates.

18. The light reflection-diffusion sheet according to claim 13, wherein the weight percentage (weight %) of said adhesive in said diffusion layer is from 1 weight % to 60 weight %.

19. The light reflection-diffusion sheet according to claim 13, wherein the weight % of said adhesive in said diffusion layer is from 1 weight % to 50 weight %.

20. The light reflection-diffusion sheet according to claim 13, wherein the weight % of said adhesive in said diffusion layer is from 1 weight % to 30 weight %.

21. The light reflection-diffusion sheet according to claim 13, wherein said diffusion particles are organic or non-organice diffusion particles.

22. The light reflection-diffusion sheet according to claim 21, wherein the material for said organic diffusion particles is selected from PMMA, polymethoxy benzyl acetate (PMBA), PVC, silicon gel, PU and PS.

23. The light reflection-diffusion sheet according to claim 22, wherein the material for non-organic diffusion particles is selected from SiO2 and Al2O3.

24. The light reflection-diffusion sheet according to claim 13, wherein the weight % of said diffusion particles in said diffusion layer is from 1 weight % to 99 weight %.

25. The light reflection-diffusion sheet according to claim 13, wherein the weight % of said diffusion particles in said diffusion layer is from 10 weight % to 60 weight %.

26. The light reflection-diffusion sheet according to claim 13, wherein the weight % of said diffusion particles in said diffusion layer is from 5 weight % to 50 weight %.

27. The light reflection-diffusion sheet according to claim 1, wherein the thickness of said diffusion layer is from 50 to 300 μm.

28. The light reflection-diffusion sheet according to claim 1, wherein said light reflection-diffusion sheet is flat or wavy.

29. The light reflection-diffusion sheet according to claim 1, wherein said light reflection-diffusion sheet is right below said light source.

30. The light reflection-diffusion sheet according to claim 1, wherein said light reflection-diffusion sheet is at the side of said light source, and a light guide plate, which is disposed to said backlight module, can guide the lights of said light source into said light reflection-diffusion sheet.

31. A method for forming the light reflection-diffusion sheet according to one of claims 1 to 3 and 6 to 27, comprising the steps of:
providing a transparent or semi-transparent layer;
forming a diffusion layer on one surface of said transparent or semi-transparent layer; and
forming a non-transparent layer on the other surface of said transparent of semi-transparent layer, said transparent or semi-transparent layer and said non-transparent layer serving as reflection layer.

32. A method for forming the light reflection-diffusion layer according to one of claims 1, 4 to 9, and 12 to 28, comprising the steps of:
providing a non-transparent layer as a reflection layer; and
forming a diffusion layer on one surface of said non-transparent layer.

33. The method according to claim 31 or 32, wherein said diffusion layer is formed by coating.

34. The method according to claim 31 or 32, wherein said diffusion layer is formed by static spraying.

35. The method according to claim 31, wherein said non-transparent layer is formed on the other surface of said transparent or semi-transparent layer by roller-bonding.

36. The method according to claim 30, wherein said non-transparent layer is formed on another surface of said transparent or semi-transparent layer by electroplating or evaporating.

37. The method according to claim 31 or 32, further comprising the step of forming said light reflection-diffusion sheet in a concave-convex shape by roll-pressing.

38. The method according to claim 37, wherein said roll-pressing uses wavy-shaped rollers.

39. A display apparatus, wherein a backlight module is disposed, said backlight module having the light reflection-diffusion sheet according to claim 1.

40. The display apparatus according to claim 39, wherein the backlight module is of direct-in lighing type.

41. The display apparatus according to claim 39, wherein the backlight module is of edge lighting type.

42. The display apparatus according to claim 39, wherein said light source is a linear light source.

43. The display apparatus according to claim 39, wherein said light source is a point light source.
